(19) United States
(12) Patent Application Publication
(10) Pub. No.: US 2025/0044416 A1
(43) Pub. Date: Feb. 6, 2025

(54) METHOD FOR PRODUCING A COVER FOR A SENSOR MODULE

(71) Applicant: SAINT-GOBAIN GLASS FRANCE, COURBEVOIE (FR)

(72) Inventors: Sebastian SCHMIDT, HERZOGENRATH (DE); Laurent FRIOCOURT, HERZOGENRATH (DE); Uwe WEISSENBERGER, HERZOGENRATH (DE); Jens SCHNEIDER, HERZOGENRATH (DE)

(21) Appl. No.: 18/720,514

(22) PCT Filed: Dec. 7, 2022
(86) PCT No.: PCT/EP2022/084795

§ 371 Date: Jun. 14, 2024

(30) Foreign Application Priority Data
Dec. 22, 2021 (EP) 21216707.6

(51) Int. Cl. G01S 7/481; G01S 7/497; G01S 17/931; G02B 1/111; G02B 1/14; G02B 1/18

(52) U.S. Cl. CPC G01S 7/4813; G01S 7/497; G01S 17/931; G02B 1/111; G02B 1/14; G02B 1/18; G01S 2007/4977

(57) ABSTRACT

A method for producing a cover for a sensor module and in particular for a vehicle sensor module, wherein in the order indicated a) a base body having larger dimensions as at least one cover is provided, b) a coating is arranged by a flood coating method on at least one surface of the base body, c) the cover is cut out of an inner region of the base body.

The invention is in the technical field of vehicle sensor technology and relates to a method for producing a cover for a sensor module and in particular for a vehicle sensor module having particularly good optical properties.

Current and in particular future upper and middle-class vehicles are equipped with a plurality of driver assistance systems; see, for example, US 2019/0169068 A1 or US 2021/0384622 A1. These include, for example, optical cameras, mid-range and long-range radar systems, ultrasonic sensors, rain sensors, daylight sensors, oncoming light sensors and light detection and ranging (lidar). These systems can also be combined under the term ADAS (advanced driver asset systems). They are generally used for traffic monitoring and can, for example, recognize road signs or determine the position and speed of objects outside the vehicle, such as other road users or obstacles located on the roadway. Currently, primarily optical cameras or radar systems are used for this purpose.

Accordingly, US 2019/0169068 A1 describes a windshield with a camera and a radar system, wherein an anti-fog film is applied on a small portion of the inside of the windshield.

The use of cameras has the disadvantage that object detection depends greatly on external environmental influences, in particular the existing light and weather conditions. The use of radar systems for traffic monitoring is almost independent of light and weather conditions, but the precision of the radar systems is currently insufficient for proper object recognition. In this regard, lidar (light detection and ranging) systems have proven advantageous in which the surroundings are scanned point by point by means of laser pulses having a wavelength in the infrared range, and an image of the surroundings is created. The distance of an object is determined using a propagation time measurement of the laser pulses emitted by the lidar sensor and reflected by the object. Due to the high precision in object detection and the low dependence on light and weather conditions, lidar systems are well suited to supplementing previous sensor systems. Several of these systems are already installed in some vehicles, and it can be assumed that the number will increase further.

The ADAS systems must be protected from environmental influences and a plurality of mechanical and climatic loads during driving. It is therefore indispensable that the corresponding sensors are provided with a cover for protection against environmental influences, since the systems otherwise cannot work properly. Special requirements regarding permeability of electromagnetic waves are placed on the covers. Accordingly, a cover for a black/white or RGB camera has to have as high a transmission as possible in the visual light spectrum of ˜380-780 nm, whereas a lidar cover should have as high a transmission as possible in the near infrared range (in most lidars about 905 nm). Covers for ADAS systems are known, for example, from WO 2020/148185 A1.

Typically, such covers are produced from transparent polymer bodies, for example in an injection molding or injection compression method. The covers are provided, for example, with a scratch-resistant and weather-resistant anti-wear paint or an anti-reflection coating. Suitable materials for the scratch-resistant coating or the anti-reflection coating are known to a person skilled in the art. Furthermore, various methods are known for producing coatings of this kind on plastic articles. These systems can be applied, for example, via dipping methods, spin coating, spray methods or a flood coating, preferably via dip or flood coating methods.

In addition to sufficiently good permeability by the electromagnetic radiation of the particular sensor installed behind the cover, a particularly high optical quality of the cover is necessary. Since typical sensor modules and their covers are very small, a particularly high optical quality is desirable over as large a region of the cover as possible.

It is therefore the object of the present invention to overcome the disadvantages of the prior art and to provide a method for producing covers for sensor modules, wherein the produced covers have a high optical quality over a large region. In addition, both a very good protection of the sensor modules against environmental influences and good permeability in the respective wavelength ranges of the operating sensors are to be provided by the cover.

According to the proposal of the invention, these and further objects are achieved by a method for producing covers for sensor modules and in particular for vehicle sensor modules according to the independent patent claim. Advantageous embodiments of the invention emerge from the dependent claims.

In the method according to the invention for producing a cover according to the invention for a sensor module and in particular for a vehicle sensor module, first a base body (hereinafter also referred to as a gross part) having greater dimensions than at least one cover (hereinafter also referred to as net part) is provided.

A coating is then arranged by a flood coating method on at least one, preferably precisely one, surface of the base body.

The cover is then separated from an inner region of the base body.

The method according to the invention therefore consists of the production of a base body as a gross part with an oversize, from which one or more covers (net parts) can be removed from regions which have an optimal optical quality. Specifically, this means that the net parts are milled or cut out of coated bodies or plates, wherein edge regions with possible stresses, distortion, insufficient coating spots or fat edges are discarded. The cover can have different sizes and shapes; they can preferably be flat/planar, one or two-dimensionally curved or designed as a cylindrical cutout. The base body or the cover advantageously has a large extent in two directions (length c or a, width d or b) which are much greater than the material thickness D of the cover. The surface of the base body therefore advantageously relates to the surface of the base body which is spanned by the large dimensions (length, width). The inner region of the base body advantageously relates to the surface of the base body which is spanned by the large dimensions (length, width). The inner region of the base body accordingly lies within this area.

The material thickness D of the base body is advantageously in the range of 1 mm to 4 mm, preferably 1.5 mm to 3.5 mm.

In an advantageous embodiment of the method according to the invention, the base body is produced in the first method step (step (a)) by an injection molding method or by an injection compression method. Injection compression molding is another development of injection molding for producing high-precision or very large components made of plastic and is sufficiently known to a person skilled in the art. In this case, the plastic melt is injected as a so-called mass cake into the practically pressure-free, not completely closed mold. The mold is completely closed only during the solidification process. The closing pressure that is uniformly built up thereby ensures the final shape of the molded part. In many plastics, injection compression provides molded parts with a very good surface, low mechanical anisotropy and low inherent stresses. Furthermore, the required closing force is reduced so that larger components can be produced on a given machine, or a smaller machine can be used for a given component.

The base body and accordingly also the cover consist at least sectionally, preferably completely, of a polymer material and preferably of a transparent polymer material. The polymer material contains or consists advantageously of polycarbonate (PC), polymethyl methacrylate (PMMA), styrene acrylonitrile (SAN), polyethylene terephthalate (PET), and/or copolymers or mixtures thereof. In a preferred embodiment (for example for lidar sensors), the polymer material can be colored with special dyes which appear black in the visual spectrum, but are transparent in the wavelength range of 905 nm or 1550 nm relevant to the lidar sensor.

It goes without saying that a base body can also be formed from a plurality of portions with different polymer materials and thereby different physical and in particular optical properties.

In another advantageous embodiment of the method according to the invention, the cover is cut out at a distance v from the outer edge of the base body of at least 0.5 cm, preferably at least 1 cm, particularly preferably from 1 cm to 3 cm and especially from 1 cm to 2 cm. Such distances are sufficient to separate an optically high-quality region of the base body so that a cover with particularly good optical properties can be produced. In particular, the base body (gross part) according to the invention can therefore be provided with sufficient flow-on area and drip-off area which are later removed in order to prevent paint from wrapping around the back/inside of the cover or to prevent fat edges.

In another advantageous embodiment of the method according to the invention, the cover is cut out of the base body in the third method step (step (c)), preferably by laser beam cutting or water jet cutting, or is sawn out. Alternatively, the cover can be cut out from the base body by milling. The cover is preferably milled out of the base body using a milling head with a C-profile. In this way, a rounded, aesthetically pleasing edge of the cover can be produced. The edge radius R is usually greater than or equal to half the material thickness D of the cover (R≥½ D).

In another advantageous embodiment of the method according to the invention, a cover is cut out of a base body. Preferably, more than one, particularly preferably two, four, six or eight covers are made from a single base body. Losses by waste can thereby be reduced.

In another advantageous embodiment of the method according to the invention, a coating is arranged on the base body in the second method step (step (b)). The coating advantageously consists of a coating for increasing the scratch resistance (anti-scratch coating), an anti-fog coating and/or an antireflective coating.

Coatings for increasing the scratch resistance consist of a scratch-resistant and weather-resistant anti-wear paint, a so-called hard coat, which is intended to protect the cover from environmental influences. Both thermally-curing paint systems based on polysiloxanes, UV-curing paint systems based on acrylates or methacrylates, and paint systems based on polyurethanes can be used for this purpose.

Such coatings can be applied by means of flooding, spray or inmold coating methods. The coating according to the invention is carried out by a flood coating method which ensures optimal surface quality.

In the case of flood coating, a continuous paint flow is preferably applied to the upper edge of the component (here the base body), wherein the component is fixed on a holder at a specific angle between 0° and 90° relative to the horizontal. The paint runs over the workpiece surface and forms a paint film there. The application is advantageously carried out by a robot with a painting nozzle, which runs a program adapted to the respective workpiece geometry and coats the interior and/or outside of the workpiece. Excess paint drips from the component and is returned to the paint circuit.

The formation of the paint film in the flood coating process is predominantly gravity-driven. Unlike, for example, in spray painting in which the paint film comes to a standstill after a few seconds, the flow dynamics in the flood coating process are maintained over a longer period of time and must be guaranteed to be trouble-free in terms of component geometry. For example, the component may not have any scooping elements or small radii (sharp edges).

In the method according to the invention, the component edges are also a critical region with regard to the paint profile, in particular in the flow-on and drip-off region of the component. The flow-on region is the upper region of the component in relation to its position on the component holder (painting frame) at which the paint flow is applied via a painting nozzle. The drip-off region is accordingly the lower component edge over which the paint drips off. A required layer thickness of the coating can often not be achieved at the flow-on edge, or so-called paint curtains form due to a non-perfectly configured flow-on edge. So-called fat edges are generally formed at the drip-off edge. This is an excessive buildup of paint with visible bead formation. Defects can also occur at component edges vertical relative to the painting position. Such defects can interfere with or deflect the beam path of the electromagnetic radiation transmitted by the sensor or the surroundings and accordingly impair the function of the sensor.

The particular advantage of the method according to the invention is shown here in which the problematic regions are removed by milling or cutting off from the base body (the gross part).

Manufacturing with a gross and a net part results in a further advantage. A net part can only be coated with great difficulty on one side; the painting robot arm or the painting nozzle would have to be moved along the flow-on edge of the net part with maximum precision in order to prevent the paint from wrapping around the rear/inside. In practice, experience has shown that this is impossible, and that “spillover” of the paint and the formation of numerous paint runs on the rear/inside must be expected, which are an immediate reason for rejecting the cover. A one-sided coating with a scratch-resistant coating (hard coat) can, however, be desired, since only the surface forming the outside of the cover has to be protected by a scratch-resistant coating. The inside (in the installation position, for example in a vehicle) of the cover is generally housed; the surface of the inner side can instead bear an advantageous anti-reflection coating (AR) in order to minimize a loss of photons or a reduction in the transmission. Alternatively, an anti-fog coating can be arranged on the inside surface of the cover, which prevents the cover from fogging on the inside.

Both thermally curing one- or two-layer systems based on polysiloxanes and UV-curing systems based on acrylates can be used as the anti-scratch coating (hard coat). In the case of a thermally curing system, the finished cured paint layers typically have layer thicknesses of 0.4 μm to 4.0 μm for the so-called primer layer, or 2.0 μm to 15 μm for the so-called hard coat layer. The layer thickness of a UV-curing hard coat usually consists of a single-layer system and is typically from 5.0 μm to 20.0 μm. Alternatively, 2-component reactive PUR systems with a self-healing effect can also be applied to the cover. Such systems can be applied, for example, in an inmold method and not infrequently have layer thicknesses of 250 μm to 1000 μm.

In another advantageous embodiment of the method according to the invention, the inside and outside of the cover, for example of polycarbonate (PC), both only bear a coating selected from an anti-scratch coating, anti-fog coating or antireflective coating.

Another aspect of the invention comprises a cover which is produced according to the method according to the invention.

The cover according to the invention forms the outer visible surface of a sensor module and in particular of a vehicle sensor module, and protects both the (optical) sensors, for example a camera or lidar sensors, and also the associated electronics from environmental influences. These not only include precipitation and headwind, but also UV radiation and other disturbing influences. The surface of the coating on the base body or the coating-free surface of the base body preferably forms the outer surface of the sensor module.

In another embodiment of the invention, the cover according to the invention is transparent to light of the visible region (˜380-780 nm). Optimal operation in particular of a camera or a rain sensor working in the visible range, a light sensor, oncoming light sensor, of a sensor module is accordingly ensured. This region is hence preferably transparent in order to generate no color changes and color distortions.

In the context of the present invention, transparent means having a transmission of more than 70%, preferably more than 80%, particularly preferably more than 90%, and in particular more than 95%.

In another embodiment of the invention, the cover according to the invention is transparent to light having wavelengths in the IR range, and in particular of the lidar operational range. Lidar sensors generally operate in a wavelength range of 800-1100 nm, in particular at about 905 nm, which is associated with the near infrared spectrum. Likewise, other sensors, such as IR operating rain sensors or distance sensors, also operate within this range. Preferably, the cover is opaque or black viewed from the outside. Light of the visible range can thereby be blocked for the IR sensor, and good operating safety and accuracy of the IR sensor, in particular of the lidar sensor, is ensured.

The cover according to the invention is advantageously dimensioned and positioned such that it covers at least the entire beam path of the sensors.

In an advantageous embodiment of a cover according to the invention, the wavefront error in all see-through zones of the cover (i.e., in particular also in the corners) is less than 75 μrad. The wavefront error describes the difference in magnitude between an averaged transmitted wavefront through a reception region minus an averaged transmitted wavefront through a transmission region: |<TWS_{RX}>−<TWS_{TX}>|, wherein TWS_{RX} represents the average transmitted wavefront of the reception aperture, and TWS_{TX} represents the average transmitted wavefront of the transmitted beam in the region TX. The wave front error accordingly provides a measure of the deviation of a specific optical system from an ideal.

The cover according to the invention can have very different shapes and designs and can even be shaped such that it is integrated into existing add-on parts or replaces them. Examples of such add-on parts are A, B or C pillars or their trims, front trims, radiator grilles or radiator trims, spoilers, rear trims or roof trims.

The cover according to the invention can preferably additionally have a film with a de-icing function.

Such films with a de-icing function are described, for example, in European Patent EP 1438172 B1. In general, this is a thin polymer film, for example a polycarbonate film, which carries heating wires. The film with the de-icing function can be integrated or applied in or on the cover according to the invention by means of film insert molding (FIM).

It can thereby be ensured that the sensor functions are not significantly adversely affected even in winter by icing or by fogging.

Another aspect of the invention relates to a sensor module and in particular a vehicle sensor module which has a cover as described above as according to the invention.

In an advantageous embodiment, the sensor module according to the invention comprises at least one optical sensor, preferably an optical camera or a light detection and ranging sensor.

Within the scope of the present invention, preferred embodiments mentioned with regard to individual features can also be freely combined with one another, as long as they are not contradictory.

Another aspect of the invention comprises the use of a cover according to the invention or sensor module according to the invention in an advanced driver assist system, preferably for systems with optical cameras, mid-range and long-range radar systems, ultrasonic sensors, rain sensors, daylight sensors, oncoming light sensors and/or light detection and ranging sensors.

The invention is explained in more detail below with reference to exemplary embodiments, wherein reference is made to the accompanying figures. In a simplified, not-to-scale representation:

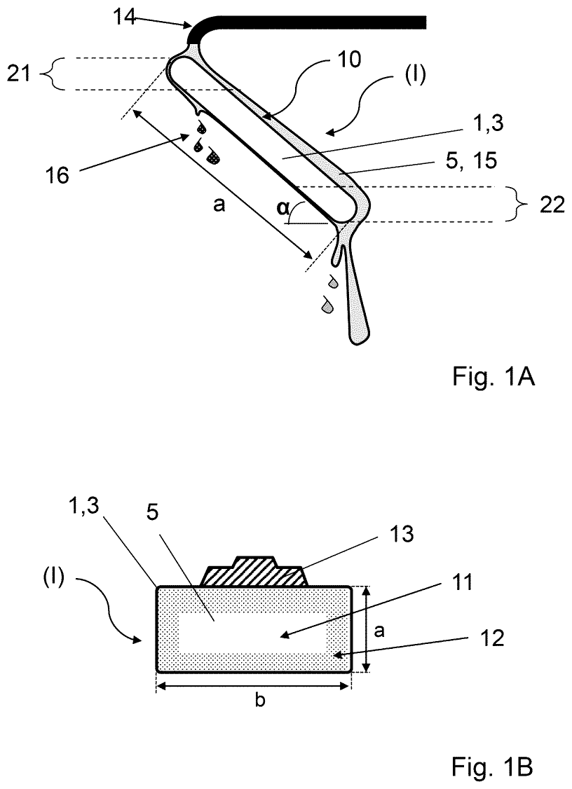

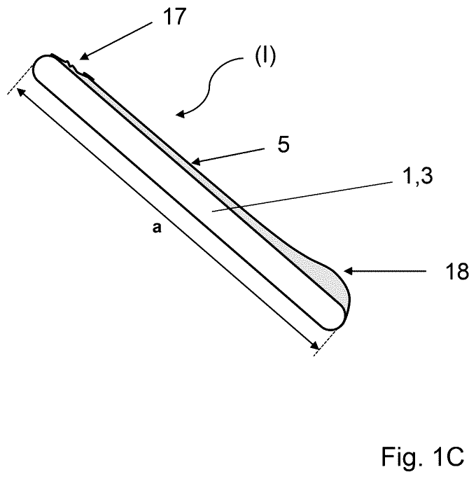

FIG. 1A shows a schematic cross-sectional view of a flood coating process of a base body of a cover according to the prior art,

FIG. 1B shows a schematic plan view of a base body according to the prior art according to FIG. 1A,

FIG. 1C shows a schematic cross-sectional view of a cover according to the prior art with paint irritation and a so-called fat edge according to FIG. 1B,

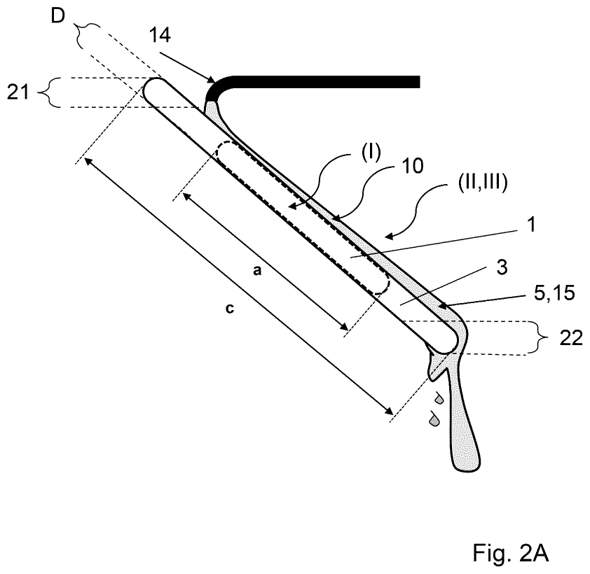

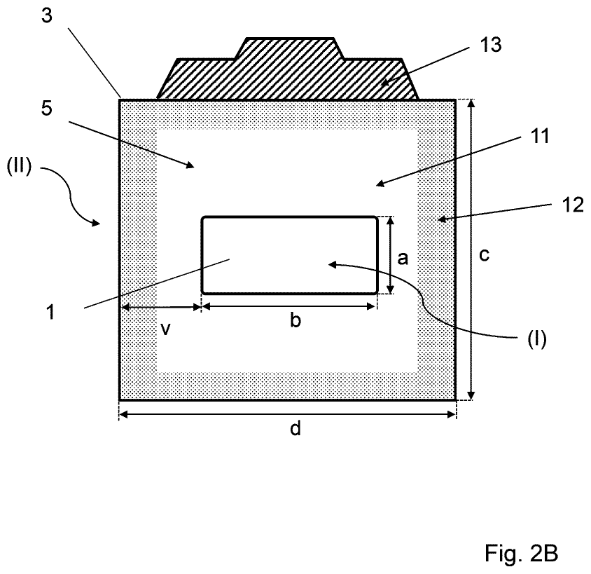

FIG. 2A shows a schematic cross-sectional view of an exemplary embodiment of the flood coating process according to the invention of a base body according to the invention for producing a cover according to the invention,

FIG. 2B shows a schematic plan view of a base body according to the invention for producing a cover according to the invention according to FIG. 2B,

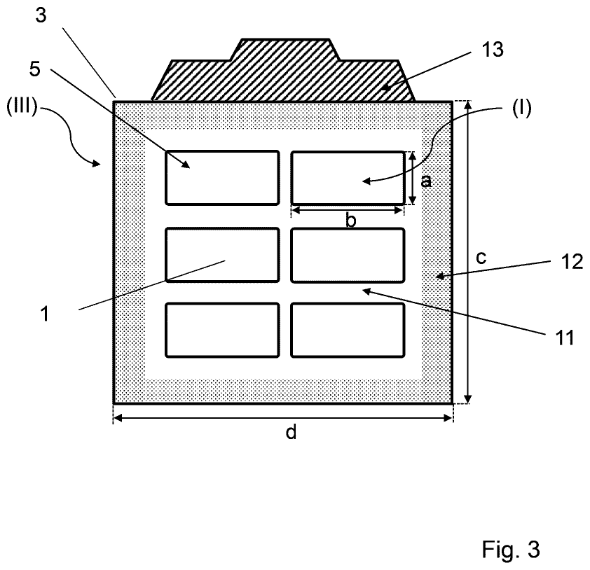

FIG. 3 shows a schematic plan view of a base body according to the invention for producing six covers according to the invention,

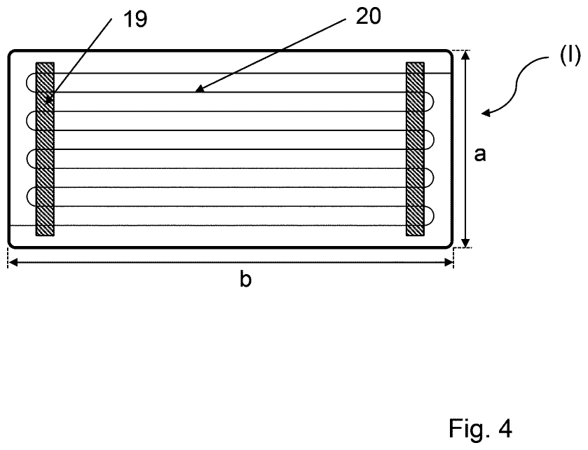

FIG. 4 shows a schematic plan view of a cover according to the invention with an additional heating element and busbars, and

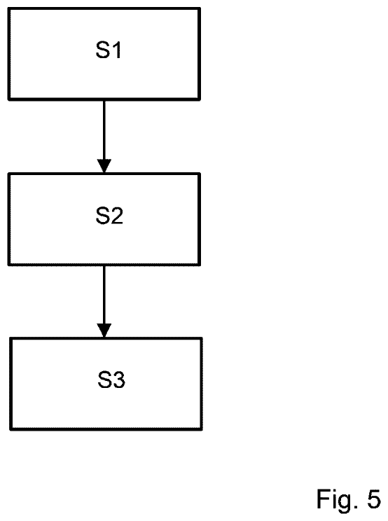

FIG. 5 shows a schematic representation of the different steps of the method according to the invention for producing a cover according to the invention.

FIG. 1A schematically shows the flood coating process of a base body 3 for producing a cover 1 according to the prior art in a cross-sectional view.

The base body 3 consists, for example, of a transparent polymer material produced by means of an injection molding method, for example of polycarbonate.

The base body 3 can have different sizes and shapes. It can preferably be flat/planar, one or two-dimensionally curved, or designed as a cylinder cutout. The representation selected in the figures as a flat plate is not intended to limit the invention in any way.

The base body 3 is coated with a coating 5 (paint layer) with the aid of a painting robot. The coating 5 is, for example, an anti-scratch coating.

For this purpose, the painting robot applies a paint 15 to the upper edge of the base body 3 via a painting nozzle on a painting robot arm 14 to form the coating 5. The surface 10 of the base body 3 to be coated has a so-called painting angle α (alpha) of, for example, 45° relative to the horizontal. A majority of the paint 15 flows along the upper side 10 of the base body 3 and forms a coating 5 on the base body 3. FIG. 1A shows the flow-on region 21 and the drip-off region 22 of the paint 15.

Furthermore, rear-side paint wrapping 16 is shown, i.e., the paint 15 flows over the upper edge of the base body 3 onto the side facing away from the surface 10 and remains there or drips off there.

FIG. 1B shows a schematic plan view of the surface 10 of a base body 3 which is produced with a coating 5 by the flow coating according to FIG. 1A. FIG. 1B also shows the so-called (fan) sprue 13 in which the polymer material is injected into the injection mold. This is usually removed in the flood coating process before or after the coating.

FIG. 1C shows a schematic cross-sectional view of a cover 1 according to the prior art according to FIG. 1B.

FIG. 1A-C shows a cover 1 or a base body 3 according to the prior art. The dimensions of the cover 1 (here, for example, a rectangular shape with a length a and a width b) correspond to the dimensions of the base body 3.

In the cross-sectional view according to FIG. 1C, the usual disadvantages of a cover 1 which are produced according to the prior art method are shown. For example, there is a region with thin paint or paint irritations 17 on the upper edge of the cover 1 and a region with a thickening of the coating 5, a so-called fat edge 18, on the lower edge of the cover 1.

Both the paint irritation 17 and the fat edge 18 or other thickness or paint variations at the side regions or on the surface of the cover 1 (not shown here) facing away from the surface 10 or other paint defects lead to optical inadequate regions 12 which here surround an inner region with optically good quality 11.

FIG. 2A shows a schematic cross-sectional view of an exemplary embodiment according to the invention of a flood coating process of a base body 3 according to the invention for producing a cover 1 according to the invention.

FIG. 2B shows a schematic plan view of the surface 10 of a base body 3 according to the invention for producing a cover 1 according to the invention according to FIG. 2A.

A polymer material which has a high mechanical stability, a high impact resistance, a very good resistance to environmental influences such as UV light and weathering can be selected for the base body 3. The base body 3 here consists, for example, of a transparent polymer material produced by means of an injection molding method, for example of polycarbonate.

It goes without saying that the base body 3 can also consist of other polymer materials. Alternatively, the base body 3 can have a plurality of portions with different polymer materials and thereby different physical and in particular optical properties.

The base body 3 can have different sizes and shapes. It can preferably be flat/planar, one or two-dimensionally curved, or designed as a cylinder cutout. The representation selected in the figures as a flat plate is not intended to limit the invention in any way.

The material thickness D of the cover 1 is, for example, in the range of 1 to 4 mm, preferably 1.5 to 3.5 mm.

The base body 3 is coated with a coating 5 (paint layer) with the aid of a painting robot. The coating 5 is, for example, an anti-scratch coating.

For this purpose, the painting robot applies a paint 15 on the upper edge of the base body 3 via a painting nozzle on a painting robot arm 14 for forming the coating 5 on a flow-on region 21. The surface 10 of the base body 3 to be coated has a so-called painting angle α (alpha) of, for example, 45° relative to the horizontal. Since the flow-on region 21 lies on the surface 10 of the base body 3, all the paint 15 flows along the upper side 10 of the base body 3 and forms a coating 5 on the base body 3. A rear-side paint wrapping as occurs with the reference sign 16 in FIG. 1A according to the prior art can thereby be avoided.

FIG. 2B shows a schematic plan view of the surface 10 of a base body 3 which is produced with a coating 5 by the flow coating according to FIG. 2A. FIG. 2B also shows the so-called (fan) sprue 13 in which the polymer material is injected into the injection mold.

The base body 3 shown in FIGS. 2A and 2B as a gross part (II) has an oversize with the dimensions c*d, from which a cover 1 with the dimensions a*b can be removed as a net part (I). The cover 1 is therefore removed from the optically good region 11 of the base body 3. The distance v of the region of the cover 1 from the outer edge of the base body 3 is sufficiently dimensioned to ensure a high optical quality of the cover 1.

After the flood coating in the second method step (b), the cover 1 is cut out of the base body 3 by milling. Since the region of the cover 3 is coated with a particularly homogeneous coating 5 without paint defects, thin paint or paint irritations 17 and without a fat edge 18, a cover 1 with particularly good optical properties arises which satisfies the special requirements of modern driver assistance systems.

FIG. 3 shows a schematic plan view of the surface 10 of a base body 3 according to the invention for producing six covers 1 according to the invention. Reference is made to FIGS. 2A and 2B for the details of the production method, so that only the differences will be discussed here.

The base body 3, that is to say the gross part (III), has the dimensions c*d which are greater than the region which, for example, comprises six covers 1 in two columns with three rows each. Six covers 1 with particularly good optical properties can be produced being cut out. At the same time, the waste per cover is significantly reduced, since the common edge regions are reduced.

FIG. 4 shows a schematic plan view of a cover 1 according to the invention with an additional heating element. For this purpose, the cover 1 has a film, for example a polycarbonate film, on which heating wires 20 and two busbars 19 are arranged, for example. The heating wires 20 and the busbars 19 are first applied to the polycarbonate film, for example, and are then connected to the base body 3 by film back injection molding.

FIG. 5 shows a schematic representation of the different steps of the method according to the invention for producing a cover according to the invention, wherein:
in a first step S1, a base body 3 with greater dimensions is provided as at least one cover 1,
in a second step S2, a coating 5 is arranged by a flood coating method on at least one, preferably precisely one, surface 10 of the base body 3, and
in a third step S3, the cover 1 is cut out of an inner region of the base body 3.

### LIST OF REFERENCE SIGNS

1 Cover
3 Base body
5 Coating
10 Surface of the base body 3
11 Optically good region
12 Optically inadequate region
13 Sprue
14 Painting robot arm
15 Paint
16 Wrapped paint
17 Thin/paint irritation
18 Fat edge
19 Busbar
20 Heating wire
21 Flow-on region
22 Drip-off region
I Net part
II, III Gross part
α (alpha) Painting angle
A Length of the cover 1
B Width of the cover 1
c Length of the base body 3
D Width of the base body 3
D Thickness, material thickness
V Distance

1. A method for producing a cover for a sensor module, the method comprising in the following order:
a) providing a base body having larger dimensions as at least one cover,
b) arranging a coating by a flood coating process on at least one surface of the base body, and
c) cutting out the cover of an inner region of the base body at a distance v from an outer edge of the base body of at least 0.5 cm.

2. The method according to claim 1, wherein the cover is cut out at a distance v from the outer edge of the base body of at least 1 cm.

3. The method according to claim 1, wherein the base body is produced in step a) by an injection molding method.

4. The method according to claim 1, wherein the cover in step c) is cut out of the base body.

5. The method according to claim 1, wherein at least one cover is cut out of the base body.

6. The method according to claim 1, wherein in step b), a coating for increasing the scratch resistance, an anti-fog coating and/or an anti-reflection coating is arranged on the base body as the coating.

7. A cover, produced according to claim 1, wherein the cover contains or consists of, at least sectionally a transparent polymer material.

8. The cover according to claim 7, wherein the cover is transparent to electromagnetic radiation in the visible wavelength range and/or in the infrared wavelength range.

9. The cover according to claim 7, wherein a wave front error in all see-through zones of the cover is less than 75 μrad.

10. The cover according to claim 7, wherein the cover additionally has a film with a de-icing function.

11. A sensor module, comprising:
a cover according to claim 7, and
at least one optical sensor.

12. The sensor module according to claim 11, wherein a beam path of the optical sensor is directed at least sectionally through the cover.

13. The sensor module according to claim 11, wherein the cover is an outer visible surface of the sensor module.

14. A vehicle having a cover according to claim 7, wherein the cover or the sensor module is part of an add-on part of the vehicle or a complete add-on part of the vehicle.

15. A method comprising providing a cover according to claim 7 in an advanced driver asset system.

16. The method according to claim 1, wherein the sensor module is a vehicle sensor module.

17. The method according to claim 1, wherein the coating is arranged on exactly one surface of the base body.

18. The method according to claim 2, wherein the cover is cut out at the distance v from the outer edge of the base body from 1 cm to 3 cm.

19. The method according to claim 3, wherein the base body is produced in step a) by an injection compression molding method.

20. The method according to claim 4, wherein the cover in step c) is sawn or milled by laser beam cutting or water jet cutting of the base body.
